(19) United States
(12) Patent Application Publication
(10) Pub. No.: US 2025/0215198 A1
(43) Pub. Date: Jul. 3, 2025

(54) NOVEL COMPOSITE MATERIAL, METHOD FOR PRODUCING COMPOSITE MATERIAL, AND COMPOSITE

(71) Applicants: KYOCERA Corporation, Kyoto-shi, Kyoto (JP); Tohoku University, Sendai-shi, Miyagi (JP)

(72) Inventors: Hirotomo NISHIHARA, Sendai-shi (JP); Shigeyoshi YOSHIDA, Sendai-shi (JP); Ken UCHIDA, Chuo-ku (JP)

(73) Assignees: KYOCERA Corporation, Kyoto-shi, Kyoto (JP); Tohoku University, Sendai-shi, Miyagi (JP)

(21) Appl. No.: 18/851,958

(22) PCT Filed: Mar. 28, 2023
(86) PCT No.: PCT/JP2023/012667

§ 371 Date: Sep. 27, 2024

(30) Foreign Application Priority Data
Mar. 29, 2022 (JP) 2022-054115

(51) Int. Cl. C08L 1/02; C08K 3/04; C08K 7/24; C08K 9/02

(52) U.S. Cl. CPC C08L 1/02; C08K 3/042; C08K 7/24; C08K 9/02; C08K 2201/006; C08L 2205/16

(57) ABSTRACT

A composite material having a honeycomb structure including a cellulose nanofiber and a carbon material that includes at least one selected from a carbon material (a) and a carbon material (b). The carbon material (a) includes at least one selected from a first shell-shaped body and a second shell-shaped body, the first shell-shaped body including a hollow particle having one pore, and the second shell-shaped body having a shape in which hollow particles are connected and having a plurality of pores. The carbon material (b) includes at least one selected from a core-shell particle in which a surface of an inorganic particle is coated with a carbon layer and a core-shell connected body in which a surface of a connected body of inorganic particles is coated with a carbon layer.

### TECHNICAL FIELD

The present disclosure relates to a novel composite material, a method for producing the composite material, and a composite including the composite material.

### BACKGROUND OF INVENTION

Carbon materials have received great attention. For example, graphene is a substance containing a two-dimensional crystal made of carbon atoms, and has excellent electrical, thermal, optical, and mechanical properties. Graphene is expected to have a broad range of applications in areas such as, for example, graphene-based composite materials, nanoelectronics, flexible/transparent electronics, nanocomposite materials, supercapacitors, batteries, hydrogen storage, nanomedicine, and bioengineered materials.

Graphene needs to be dispersed to exhibit excellent electrical, thermal, optical, and mechanical properties. However, graphene tends to aggregate due to van der Waals force. As a method for dispersing graphene, for example, Patent Document 1 discloses a method including dispersing and stabilizing graphene with polyvinylpyrrolidone in a solvent to form a dispersion. Patent Document 2 discloses a porous graphene material having a pore diameter of from 1 nm to 10 μm and a specific surface area of from 100 m²/g to 2000 m²/g, and the porous graphene material is considered to be less likely to aggregate.

On the other hand, cellulose nanofibers have excellent properties, for example, shape control such as size, structure, and shape, and physical properties such as light weight and strength, and they are materials expected to be used in various fields in the future. For example, Patent Document 3 discloses a nanocellulose-nanocarbon composite structure in which nanocellulose including a cellulose nanofiber and nanocarbon including one or two or more selected from a carbon nanotube, graphene, and highly crystalline carbon black are combined at a nano level.

### CITATION LIST

### Patent Literature

Patent Document 1: JP 2014-009104 A
Patent Document 2: JP 2014-507365 T
Patent Document 3: JP 2020-164378 A

### SUMMARY

### Problem to be Solved

In Patent Document 1, since graphene is in a state of a dispersion, it is necessary to evaporate or dry a solvent to form a composite. However, when the solvent volatilizes, graphene may aggregate again.

In the porous graphene material described in Patent Document 2, carbon derived from graphene oxide and carbon derived from a polymer are mixed, and thus the purity of graphene is low. In addition, carbon derived from graphene oxide contains a large number of defects even after heat treatment, and thus has low quality and cannot sufficiently exhibit an effect inherent in graphene.

In the nanocellulose-nanocarbon composite structure described in Patent Document 3, the nanocarbon constituting the composite structure is likely to aggregate again, and the effect inherent in the nanocarbon cannot be sufficiently exhibited.

The present disclosure has been made in view of such circumstances, and the present disclosure provides a novel composite material in which at least one of anisotropy, electromagnetic wave absorbability, weight reduction, and insulation properties is improved, a method for producing the composite material, and a composite including the composite material.

### Solution to Problem

As a result of intensive studies to solve the above-described problems, the inventors of the present invention have found that the problems can be solved by the invention shown below.

That is, the present disclosure relates to the followings.
[1] A composite material having a honeycomb structure including a cellulose nanofiber and a carbon material,
the carbon material including at least one selected from a carbon material (a) and a carbon material (b), the carbon material (a) including at least one selected from a first shell-shaped body and a second shell-shaped body, the first shell-shaped body including a hollow particle having one pore and the second shell-shaped body having a shape in which hollow particles are connected and having a plurality of pores, and the carbon material (b) including at least one selected from a core-shell particle in which a surface of an inorganic particle is coated with a carbon layer and a core-shell connected body in which a surface of a connected body of inorganic particles is coated with a carbon layer.
[2] The composite material according to [1], wherein in the carbon material (a), shell portions of the first shell-shaped body and the second shell-shaped body are made of graphene having an average number of layers of 4 or less, and in the carbon material (b), the carbon layer is made of graphene having an average number of layers of 4 or less.
[3] The composite material according to [1] or [2], wherein the carbon material (a) has a specific surface area of 657 m²/g or more.
[4] The composite material according to any of [1] to [3], wherein in the carbon material (a), volumes of the pore of the first shell-shaped body and the pores of the second shell-shaped body are 1.0 cc/g or more.
[5] The composite material according to any of [1] to [4], wherein a honeycomb opening diameter of the honeycomb structure is not less than 0.2 μm and not more than 200 μm.
[6] The composite material according to any of [1] to [5], wherein a content of the carbon material contained in the composite material is not less than 5 mass % and not more than 95 mass %.
[7] The composite material according to any of [1] to [6], wherein the honeycomb structure is made of the cellulose nanofiber and the carbon material.
[8] The composite material according to any of [1] to [6], wherein the honeycomb structure is made of the cellulose nanofiber, and the carbon material is attached to a surface of the honeycomb structure.
[9] A method for producing the composite material according to [7], the method including mixing a carbon material and an aqueous dispersion containing a cellulose nanofiber and freezing, the carbon material including at least one selected from a carbon material (a) and a carbon material (b), the carbon material (a) including at least one selected from a first shell-shaped body and a second shell-shaped body, the first shell-shaped body including a hollow particle having one pore, and the second shell-shaped body having a shape in which hollow particles are connected and having a plurality of pores, and the carbon material (b) including at least one selected from a core-shell particle in which a surface of an inorganic particle is coated with a carbon layer and a core-shell connected body in which a surface of a connected body of inorganic particles is coated with a carbon layer.
[10] The method for producing the composite material according to [8], the method including impregnating a honeycomb structure including a cellulose nanofiber with a dispersion containing a carbon material including at least one selected from a carbon material (a) and a carbon material (b), the carbon material (a) including at least one selected from a first shell-shaped body and a second shell-shaped body, the first shell-shaped body including a hollow particle having one pore and a second shell-shaped body having a shape in which hollow particles are connected and having a plurality of pores, and the carbon material (b) including at least one selected from a core-shell particle in which a surface of an inorganic particle is coated with a carbon layer and a core-shell connected body in which a surface of a connected body of inorganic particles is coated with a carbon layer.
[11] The method for producing the composite material according to [9] or [10], wherein in the carbon material (a), shell portions of the first shell-shaped body and the second shell-shaped body are made of graphene having an average number of layers of 4 or less, and in the carbon material (b), the carbon layers are made of graphene having an average number of layers of 4 or less.
[12] The composite material according to any of [1] to [8], which is an electromagnetic interference suppression material.
[13] A composite including: a composite material having a honeycomb structure including a cellulose nanofiber and a carbon material; and
at least one selected from an organic substance and an inorganic substance,
wherein the carbon material includes at least one selected from a carbon material (a) and a carbon material (b), the carbon material (a) including at least one selected from a first shell-shaped body and a second shell-shaped body, the first shell-shaped body including a hollow particle having one pore, and the second shell-shaped body having a shape in which hollow particles are connected and having a plurality of pores, and the carbon material (b) including at least one selected from a core-shell particle in which a surface of an inorganic particle is coated with a carbon layer and a core-shell connected body in which a surface of a connected body of inorganic particles is coated with a carbon layer.
[14] The composite according to [13], wherein the organic substance is a thermosetting resin.
[15] The composite according to [13] or [14], which is an electromagnetic interference suppression material.

### Advantageous Effect

The present disclosure can provide a novel composite material in which at least one of anisotropy, electromagnetic wave absorbability, weight reduction, and insulation properties is improved, a method for producing the composite material, and a composite including the composite material.

### DESCRIPTION OF EMBODIMENTS

Hereinafter, the present disclosure will be described in detail with reference to an embodiment.

In the present specification, with regard to numerical ranges (e.g., ranges of a content), lower and upper limit values described in a stepwise manner may each be independently combined.

In a numerical range described herein, the upper or lower limit value of a numerical range may be replaced by a value presented in Examples.

In the present specification, the term “graphene” means a “sheet-shaped substance of sp²-bonded carbon atoms having 10 or fewer layers”.

In the present specification, the “average number of layers” of graphene is a value obtained by the following formula. Specifically, the value is obtained by a method described in Examples described later.

$$Average number of layers of graphene = 2627 ( {m}^{2} / g ) / specific surface area ( {m}^{2} / g )$$

The specific surface area refers to a BET specific surface area, and is a value (m²/g) obtained by measurement by a BET multipoint method using nitrogen adsorption.

In the present specification, the hollow particle refers to a particle having a shell portion, whose inside surrounded by the shell portion is hollow.

In the present specification, the “honeycomb structure” means not only a regular hexagonal column but also a hollow structure in which hollow bodies having three dimensional shape such as a polygonal column, a cylinder, and an elliptic column are arranged without a gap.

In the present specification, the phrase “average particle diameter of the carbon material” refers to an average particle diameter of primary particles when the carbon material is not aggregated but in the form of primary particles, and refers to an average particle diameter of secondary particles when the carbon material is aggregated and in the form of secondary particles. The average particle diameter of the carbon material is a value calculated from the pore volume and the specific surface area, estimated with a laser diffraction-type particle size distribution meter, or calculated as a mean value of the particle diameters of particles observed in from 20 to 100 fields of view using an observation means such as a scanning electron microscope (SEM) or a transmission electron microscope (TEM). The term “particle diameter” refers to the maximum distance among distances between any two points on the contour of a particle, which pass through the center of the particle.

### <Composite Material>

A composite material of the present disclosure is a composite material having a honeycomb structure including a cellulose nanofiber and a carbon material, the carbon material including at least one selected from a carbon material (a) and a carbon material (b), the carbon material (a) including at least one selected from a first shell-shaped body and a second shell-shaped body, the first shell-shaped body including a hollow particle having one pore, and the second shell-shaped body having a shape in which hollow particles are connected and having a plurality of pores, and the carbon material (b) including at least one selected from a core-shell particle in which a surface of an inorganic particle is coated with a carbon layer and a core-shell connected body in which a surface of a connected body of inorganic particles is coated with a carbon layer. The composite material of the present disclosure, having a honeycomb structure including a cellulose nanofiber and a carbon material having a specific structure, improves at least one of anisotropy, electromagnetic wave absorbability, weight reduction, and insulation properties.

The honeycomb structure included the composite material of the present disclosure has a hollow structure in which hollow bodies having a three dimensional shape are arranged without a gap. The three dimensional shape is not particularly limited, and examples thereof include a cylinder; an elliptic column; a triangular prism; a quadrangular prism; and a polygonal prism such as a hexagonal prism and an octagonal prism. The three dimensional shape may be a polygonal prism, and it may be a hexagonal prism from the viewpoint of ease of production. Allowing graphene to be present in such a honeycomb-shaped cellulose nanofiber makes it possible to impart anisotropy to thermal conductivity and electromagnetic wave absorption ability.

An opening diameter (hereinafter, also referred to as a honeycomb opening diameter) of the hollow body (honeycomb pore) having a three dimensional shape constituting the honeycomb structure may be not less than 0.2 μm and not more than 200 μm, not less than 1.0 μm and not more than 180 μm, or not less than 5.0 μm and not more than 150 μm from the viewpoint of ease of production.

Here, in the present specification, the “honeycomb opening diameter” refers to a length (maximum length) when any two points on a contour line of the honeycomb pore are selected so that a length between the two points becomes maximum.

The honeycomb opening diameter is determined from an average value of opening diameters of 100 to 200 honeycomb pores observed in 5 to 10 visual fields using an observation means of a scanning electron microscope (SEM) or a transmission electron microscope (TEM). Specifically, measurement can be made by the method described in Examples.

The length of the honeycomb structure is not particularly limited, and it may be not less than 100 μm and not more than 2 m, not less than 200 μm and not more than 1 m, or not less than 500 μm and not more than 0.5 m. When the length of the honeycomb structure is 100 μm or more, the honeycomb structure can be designed, and when the length is 2 m or less, the honeycomb structure can be applied to a large radio wave absorption body.

The honeycomb structure may be made of a cellulose nanofiber and a carbon material, or the honeycomb structure may be made of a cellulose nanofiber, and the carbon material may be attached to a surface of the honeycomb structure.

### (Cellulose Nanofiber)

The cellulose nanofiber refers to a fibrous material having a fiber diameter of 500 nm or less, which is produced by defibrating vegetable fibers to a nano level.

The average fiber diameter of the cellulose nanofiber is not particularly limited, but it may be not less than 2 nm and not more than 100 nm, not less than 2 nm and not more than 50 nm, or not less than 2 nm and not more than 30 nm from the viewpoint of uniformizing the honeycomb structure.

The average fiber length of the cellulose nanofiber is not particularly limited, but it may be not less than 50 nm and not more than 10 μm, not less than 0.1 μm and not more than 5 μm, or not less than 0.15 μm and not more than 2 μm from the viewpoint of forming a honeycomb structure.

The average fiber diameter and the average fiber length of the cellulose nanofiber are determined by averaging fiber diameters and fiber lengths obtained from the results of observation of each fiber using an atomic force microscope (AFM). Specifically, the honeycomb opening diameter can be measured by the method described in Examples.

The average aspect ratio of the cellulose nanofiber is usually 50 or more. The upper limit is not particularly limited, but it is usually 1000 or less. The average aspect ratio can be calculated by the following Formula (1).

$$Aspect ratio = average fiber length / average fiber diameter \qquad ( 1 )$$

The raw material of the cellulose nanofiber is not particularly limited, and examples thereof include wood; bamboo; hemp; jute; kenaf; crop residue, cloth; and pulps such as needle unbleached kraft pulp (NUKP), needle bleached kraft pulp (NBKP), leaf unbleached kraft pulp (LUKP), leaf bleached kraft pulp (LBKP), needle unbleached sulfite pulp (NUSP), needle bleached sulfite pulp (NBSP), thermomechanical pulp (TMP), recycled pulp, and pulp of waste paper. One type of the cellulose material may be used, or two or more types may be used in combination.

The cellulose nanofiber may be subjected to a modification treatment. Specific examples of the modification treatment include esterification such as acetylation, phosphorylation, urethanization, carbamidation, etherification, carboxymethylation, TEMPO (2,2,6,6-tetramethylpiperidine-1-oxyl radical) oxidation, and periodic acid oxidation. The cellulose nanofiber may be subjected to a modification treatment by TEMPO oxidation from the viewpoint of ease of dispersion.

The cellulose nanofiber may be subjected to only one of these modification treatments, or may be subjected to two or more of these modification treatments.

The content of the cellulose nanofiber contained in the composite material of the present disclosure may be not less than 5 mass % and not more than 95 mass %, not less than 10 mass % and not more than 80 mass %, or not less than 20 mass % and not more than 70 mass % with respect to the total amount of the composite material. When the content of the cellulose nanofiber is 5 mass % or more, a honeycomb structure can be formed, and when the content is 95 mass % or less, the composite material obtained can be used as an electromagnetic interference suppression material.

### (Carbon Material)

The carbon material is at least one selected from a carbon material (a) and a carbon material (b), the carbon material (a) including at least one selected from a first shell-shaped body and a second shell-shaped body, the first shell-shaped body including a hollow particle having one pore, and the second shell-shaped body having a shape in which hollow particles are connected and having a plurality of pores, and the carbon material (b) including at least one selected from a core-shell particle in which a surface of an inorganic particle is coated with a carbon layer and a core-shell connected body in which a surface of a connected body of inorganic particles is coated with a carbon layer.

[Carbon Material (a)]

The carbon material (a) is at least one selected from a first shell-shaped body and a second shell-shaped body, the first shell-shaped body including a hollow particle having one pore, and the second shell-shaped body having a shape in which hollow particles are connected and having a plurality of pores.

The first shell-shaped body is a hollow particle having one pore.

The average pore diameter of the pore of the first shell-shaped body may be not less than 0.5 nm and not more than 100 nm, not less than 0.7 nm and not more than 50 nm, or not less than 1.0 nm and not more than 20 nm.

The second shell-shaped body has a shape in which hollow particles are connected to each other and has a plurality of pores.

The pores of the second shell-shaped body are not particularly limited as long as the second shell-shaped body has a plurality of pores.

The average pore diameter of one of the pores of the second shell-shaped body may be not less than 0.5 nm and not more than 100 nm, not less than 0.7 nm and not more than 50 nm, or not less than 1.0 nm and not more than 20 nm.

The average pore diameters of the pore of the first shell-shaped bodies and the pores of the second shell-shaped bodies are values obtained by the following Formula (2) on the assumption that the pores are cylindrical pores.

$$Average pore diameter of pores = 4 \times pore volume / specific surface area ( {m}^{2} / g ) \qquad ( 2 )$$

The pore volume is a value per material mass obtained from an adsorption amount at a relative pressure (P/P0) of 0.96 by performing nitrogen adsorption isotherm measurement, and the specific surface area is a BET specific surface area and is a value obtained by measurement by a BET multipoint method using nitrogen adsorption.

The average particle diameter of the first shell-shaped body may be considered to be the same as the average pore diameter of the pore of the first shell-shaped body because its shell thickness is very thin.

An average particle diameter of the second shell-shaped body may be 1.0 nm or more, 2.0 nm or more, or 5.0 nm or more from the viewpoint of ease of production, and may be 1000 nm or less, 500 nm or less, or 200 nm or less from the viewpoint of further exhibiting the effect of the present disclosure.

The average particle diameter of the second shell-shaped body can be estimated by using a laser diffraction-size particle size distribution meter.

When the carbon material (a) is not aggregated but is in the form of primary particles, the average particle diameter (primary particles) of the carbon material (a) may be 1 nm or more, 5 nm or more, or 10 nm or more from the viewpoint of ease of production, and may be 1000 nm or less, 500 nm or less, or 100 nm or less from the viewpoint of further exhibiting the effect of the present disclosure.

When the carbon material (a) is aggregated and in the form of secondary particles, the average particle diameter (secondary particles) of the carbon material (a) may be 0.1 μm or more, 1.0 μm or more, or 5.0 μm or more from the viewpoint of ease of production, and may be 200 μm or less, 100 μm or less, 50 μm or less, or 20 μm or less from the viewpoint of further exhibiting the effect of the present disclosure.

The specific surface area of the carbon material (a) may be 657 m²/g or more, 1000 m²/g or more, 1300 m²/g or more, 1500 m²/g or more, or 1700 m²/g or more from the viewpoint of further exhibiting the effect of the present disclosure. From the viewpoint of ease of production, the specific surface area may be 2627 m²/g or less, 2500 m²/g or less, 2400 m²/g or less, or 2300 m²/g or less.

The specific surface area refers to a BET specific surface area, and is a value measured by a BET multipoint method using nitrogen adsorption.

The volume of the pore of the first shell-shaped body and the volume of the pores of the second shell-shaped body may be 1.0 cc/g or more, 1.3 cc/g or more, or 1.6 cc/g or more, and 10.0 cc/g or less, 9.0 cc/g or less, or 8.0 cc/g or less from the viewpoint of further exhibiting the effect of the present disclosure. When the pore volume is 1.0 cc/g or more, a higher specific surface area can be obtained.

The pore volume is a value obtained from an adsorption amount at a relative pressure (P/P0) of 0.96 by performing nitrogen adsorption isotherm measurement.

The carbon material (a) contains carbon as a main component. Here, the phrase “contain carbon as a main component” means that the content of carbon in the carbon material is 50 mass % or more. The content of carbon in the carbon material (a) may be 80 mass % or more, 95 mass % or more, or 98 mass % or more.

[Carbon Material (b)]

The carbon material (b) is at least one selected from a core-shell particle in which a surface of an inorganic particle as a core portion is coated with a carbon layer as a shell portion and a core-shell connected body in which a surface of a connected body of inorganic particles as a core portion is coated with a carbon layer as a shell portion.

The carbon material (b) includes those in which the inside of pores of the inorganic particles is coated with carbon and those in which the inside of pores of the inorganic particles is filled with carbon.

The average particle diameter of the core-shell particles may be not less than 0.0005 μm and not more than 100 μm, not less than 0.1 μm and not more than 50 μm, or not less than 0.5 μm and not more than 20 μm from the viewpoint of ease of production and further exhibiting the effect of the present disclosure.

The average particle diameter of the core-shell particles is a value obtained by the following Formula (3) on the assumption that the pores are cylindrical pores:

$$Average particle diameter ( m ) of core - shell particles = 6 / [ specific surface area ( {m}^{2} / g ) \times true density ( g / {m}^{3} ) of core shell - particles ] \qquad ( 3 )$$

The specific surface area refers to a BET specific surface area, and is a value obtained by measurement by a BET multipoint method (for example, from 5 to 6 points) using nitrogen adsorption.

The average particle diameter of the core-shell connected body may be not less than 0.0005 μm and not more than 100 μm, not less than 0.1 μm and not more than 50 μm, or not less than 0.5 μm and not more than 20 μm from the viewpoint of ease of production and further exhibiting the effect of the present disclosure.

The average particle diameter of the core-shell connected body can be estimated by using a laser diffraction-size particle size distribution meter.

The average particle diameter of the carbon material (b) may be 100 μm or less from the viewpoint of further exhibiting the effect of the present disclosure.

The specific surface area of the carbon material (b) may be 800 m²/g or less, 780 m²/g or less, or 600 m²/g or less from the viewpoint of further exhibiting the effect of the present disclosure. The lower limit is not particularly limited, and it may be 1 m²/g or more, 5 m²/g or more, or 10 m²/g or more.

The specific surface area refers to a BET specific surface area, and is a value measured by a BET multipoint method using nitrogen adsorption.

### [Inorganic Particle]

The core-shell particle and the core-shell connected body contain an inorganic particle. The inorganic particle contained in the core-shell particle and the inorganic particle contained in the core-shell connected body (hereinafter, also collectively referred to as “inorganic particles”) are not particularly limited. Examples of the inorganic particles include inorganic particles of alumina, silica, magnesium oxide, tungsten carbide, aluminum nitride, cerium oxide, titanium oxide, calcium carbonate and the like; magnetic bodies that are magnetic metals such as pure iron; magnetic bodies that are magnetic metal alloys such as amorphous magnetic metal alloys, Ni—Fe-based alloys, mild steel, silicon steel (Fe—Si alloys), Fe—Al alloys, Fe—Si—Al alloys (sendust), and Co—Fe-based alloys; and magnetic bodies that are magnetic oxides such as carbonyl iron, magnetite, and ferrite.

Specific examples of the ferrite include Mn—Zn-based ferrite, Ni—Zn-based ferrite, Cu—Zn-based ferrite, Cu—Zn—Mg ferrite, Mn—Mg—Al ferrite, Y-type hexagonal ferrite, Z-type hexagonal ferrite, and M-type hexagonal ferrite.

The magnetic metal and the magnetic metal alloy may have a flat shape.

The inorganic particles may be appropriately selected according to the application. The inorganic particles may contain at least one selected from the group consisting of alumina, silica, magnesium oxide, tungsten carbide, and aluminum nitride, may contain at least one selected from the group consisting of alumina, silica, and magnesium oxide, or may contain alumina, from the viewpoint of improving the volume resistance.

The inorganic particles may contain silica from the viewpoint of the thermal expansion rate. From the viewpoint of the thermal conductivity, the inorganic particles may contain at least one selected from the group consisting of alumina, magnesium oxide, and aluminum nitride, or may contain alumina.

The inorganic particles may be magnetic bodies, and the magnetic bodies may include at least one selected from the group consisting of a magnetic metal, a magnetic metal alloy, and a magnetic oxide, may include an amorphous magnetic metal alloy, may include at least one selected from the group consisting of an Fe—Si—Al alloy (sendust), ferrite, and magnetite, or may include at least one selected from ferrite and magnetite, from the viewpoint of improving the electromagnetic wave absorption ability in a wide frequency range as well as improving the thermal conductivity.

The inorganic particles may be composed of one type of inorganic particles, or may include two or more types thereof.

The inorganic particles may be nanoparticles from the viewpoint of further exhibiting the effect of the present disclosure.

### [Graphene]

In the carbon material (a), the shell portions of the first shell-shaped body and the second shell-shaped body may be made of graphene having an average number of layers of 4 or less. In the carbon material (b), the carbon layer may be made of graphene having an average number of layers of 4 or less. With such a structure, the carbon material (a) and the carbon material (b) can more effectively exhibit the excellent thermal conductivity and electromagnetic wave absorption performance of graphene itself.

The graphene is a sheet-shaped substance having a hexagonal lattice structure in which carbon atoms are bonded. The graphene may be in a single-layer state having a layer thickness corresponding to one carbon atom, or may be in a multi-layer state having two or more layers, and it has four or fewer numbers of layers. The graphene may contain an oxygen atom, a hydrogen atom, or the like in addition to the carbon atom.

In the carbon material (a), the content (mass %) graphene in the first shell-shaped body and the second shell-shaped body is not particularly limited, and it may be 90 mass % or more, 95 mass % or more, or 98 mass % or more from the viewpoint of further exhibiting the effect of the present disclosure.

In the carbon material (b), the content (mass %) of graphene in the core-shell particles and in the core-shell connected body is not particularly limited, and it may be not less than 0.1 mass % and not more than 70 mass %, not less than 0.5 mass % and not more than 45 mass %, or not less than 1 mass % and not more than 20 mass % or less from the viewpoint of further exhibiting the effect of the present disclosure.

### [Method for Producing Carbon Material]

[Method for Producing Carbon Material (a)]

The carbon material (a) can be produced by, for example, a method including a first step of coating a template of particles of alumina, magnesium oxide, or the like with a carbon layer and preparing carbon-coated particles, and a second step of dissolving and removing the template. Such a method can easily produce a carbon material having a high specific surface area.

### [First Step]

### (Template)

The template at the time of synthesizing the carbon material (a) needs to be capable of introducing the organic substance on a surface of the material and inside voids thereof, to stably maintain the original structure during a CVD treatment, and to be capable of being easily separated from the formed carbon material. Therefore, it may have good heat resistance and can be removed with an acid or an alkali.

The resulting carbon material (a) has voids reflecting the shape of the template itself. In other words, the carbon material (a) is synthesized in a state in which the form of the template is transferred. Thus, the template may be a material having a material uniform in structure and composition with a uniform particle diameter, and a carbon material having pores of a controlled size can be prepared by using such a material. To obtain a high specific surface area, a material capable of controlling the average number of layers of graphene to be obtained to 4 or less may be used.

Examples of such a template include particles of alumina, silica, magnesium oxide, tungsten carbide, aluminum nitride, cerium oxide, titanium oxide, and calcium carbonate. These particles may be nanoparticles. From the viewpoint of material properties to be possessed by the template and the physical properties of the resulting carbon material (a), these particles may be particles of at least one selected from alumina and magnesium oxide, may be alumina particles, or may be alumina nanoparticles.

The type of alumina is not particularly limited, and it may be θ-alumina or γ-alumina.

The average particle diameter of the particles used for the template is not particularly limited, and the average particle diameter may be not less than 4 nm and not more than 100 nm, or may be not less than 5 nm and not more than 20 nm. An average particle diameter of 4 nm or more results in easy handling and good carbon coating properties. In addition, gas permeability of a carbon source is improved when the carbon source is coated, and thus uniform carbon coating is facilitated. On the other hand, when the average particle diameter is 100 nm or less, a carbon material (a) having a high specific surface area (BET specific surface area) can be obtained. A decrease in yield of the carbon material (a) due to a relative increase in amount of the template to be dissolved in the subsequent step can also be reduced.

The particles may be used in admixture with a particulate spacer. Using the spacer makes it possible to secure an appropriate gap between the particles, and to reduce pressure loss due to excessively dense packing of the particles. The spacer may be a particle having an average particle diameter of, for example, not less than 100 μm and not more than 5000 μm. The material for the spacer is not particularly limited as long as it can be sieved after carbon coating, and it may be a material that does not decompose at not less than 900° C. and not more than 1000° C. Alternatively, it may be a material that can be dissolved and removed simultaneously with the template. Examples of the material include quartz sand, silica, alumina, silica-alumina, and titania. For example, when quartz sand is used, the quartz sand may be washed with an acid in advance, fired at not less than 600° C. and not more than 1000° C. for not less than 1 hour and not more than 5 hours, and controlled to have the above-described particle diameter.

The blending ratio between the particles and the spacer is not particularly limited, and it may be, for example, from 0.1:10 to 10:10 or from 1:10 to 10:10 in terms of a mass ratio of (particles:spacer). When the blending ratio is within this range, the carbon material (a) may be obtained at a high yield.

(Coating with Carbon Layer)

The method for coating surfaces of the particles serving as the template with the carbon layer is not particularly limited, and either of a wet method and a dry method can be applied. Using a chemical vapor deposition (CVD) method makes it possible to obtain a carbon layer made of graphene having an average number of layers of 4 or less.

The CVD method used for introducing an organic compound and depositing a carbon layer on a template is an industrial method for forming a thin film made of a specific element or element composition (for example, a thin film made of carbon) on a substrate such as a template. In general, this is a technique utilizing a phenomenon in which energy is given to a gas containing a raw material by heat or light, or the raw material is converted into plasma at a high frequency, whereby the raw material is radicalized by chemical reaction or thermal decomposition to be rich in reactivity, and the raw material is adsorbed and deposited on the substrate.

The organic compound used in the CVD method may be a gas at room temperature (25° C.) or may be one that can be vaporized. The method of vaporization includes, for example, a method of heating to the boiling point or higher and a method of reducing the pressure in the atmosphere. The organic compound to be used can be appropriately selected from carbon source substances. In particular, the organic compound may be a compound that thermally decomposes when heated, or a compound that can deposit a carbon layer on the surface of the particle used as the template.

The organic compound to be used may be an organic compound containing hydrogen. The organic compound may be an organic compound containing an unsaturated or saturated hydrocarbon, or a mixture thereof.

The organic compound to be used may be an unsaturated linear or branched hydrocarbon having a double bond and/or a triple bond, a saturated linear or branched hydrocarbon, a saturated cyclic hydrocarbon, an aromatic hydrocarbon such as benzene or toluene, or the like. As the organic compound, alcohols such as methanol and ethanol, or compounds containing nitrogen such as acetonitrile and acrylonitrile may be used. Examples of the organic compound include acetylene, methylacetylene, ethylene, propylene, isoprene, cyclopropane, methane, ethane, propane, benzene, toluene, a vinyl compound, ethylene oxide, methanol, ethanol, acetonitrile, and acrylonitrile. One type of these organic compounds may be used, or two or more types may be used in combination. Among them, the organic compound to be used may be a compound capable of entering the gap between the particles, such as acetylene, ethylene, propylene, methane, or ethane, and methane, propylene, and benzene may be used from the viewpoint of precipitating highly crystalline carbon. Methane may be used from the viewpoint of providing carbon having a high thermal decomposition temperature and high crystallinity.

The organic compound used in CVD at a higher temperature and the organic compound used in CVD at a lower temperature may be the same or different from each other. For example, acetylene, ethylene or the like may be used in CVD at a low temperature, and propylene, isoprene, benzene or the like may be used in CVD at a high temperature.

When the organic compound is introduced onto the particles, the particles may be placed under reduced pressure in advance, or the system itself may be placed under reduced pressure. Any method may be used as long as carbon is deposited by CVD. For example, carbon generated by a chemical reaction or thermal decomposition of an organic compound may be deposited (or adsorbed) on alumina particles to coat the alumina particles with a carbon layer.

The pressure at which the CVD treatment is performed is not particularly limited and may be, for example, not less than 1 kPa and not more than 200 kPa or not less than 50 and not more than 150 kPa. Any heating temperature condition at the time of performing the CVD treatment may be used as long as a few carbon layers or less can be formed on the particles, and an appropriate temperature can be appropriately selected depending on the organic compound to be used. The heating temperature may be not less than 400° C. and not more than 1500° C., not less than 450° C. and not more than 1100° C., or not less than 550° C. and not more than 950° C. For example, when propylene is used as the organic compound, the temperature may be not less than 700° C. and not more than 900° C., and, when methane is used as the organic compound, the temperature may be not less than 900° C. and not more than 1100° C. The temperature may be lower than the decomposition temperature of the organic compound by about not less than 50° C. and not more than 200° C. When heating is performed to a temperature equal to or higher than the decomposition temperature of the organic compound, vapor phase carbon deposition becomes remarkable. However, by performing the above-described method, for example, unevenness in amount of carbon deposition between the surfaces and the inside of the particles can be reduced, and carbon can be uniformly deposited.

The heating temperature can be appropriately selected depending on the CVD treatment time and/or the pressure in the reaction system. Also, the product may be analyzed, and the temperature required to achieve a desired number of layers to be layered may be set based on the analysis results.

The rate of temperature increase during the CVD treatment is not particularly limited either, and it may be not less than 1° C./min and not more than 50° C./min or not less than 5° C./min and not more than 20° C./min. For the treatment time in the CVD treatment (CVD treatment time at a predetermined heating temperature), an appropriate time can be selected depending on the organic compound to be used or the temperature. For example, the treatment time in the CVD treatment may be not less than 5 minutes and not more than 8 hours, not less than 0.5 hours and not more than 6 hours, or not less than 1 hour and not more than 5 hours. Also, the product may be analyzed, and the time required for sufficient carbon deposition may be set based on the analysis results.

The CVD treatment may be performed under reduced pressure, in a vacuum, under pressure, or in an inert gas atmosphere. When the treatment is performed in an inert gas atmosphere, examples of the inert gas include nitrogen, helium, neon, and argon, and nitrogen may be used.

In the CVD method, carbon can be easily deposited or adsorbed on particles in a gas phase by heating the particles while flowing a gaseous organic compound together with a carrier gas so as to be brought into contact with the particles. The type, flow rate, and flow amount of the carrier gas and the heating temperature are appropriately adjusted depending on the type of the organic compound to be used. The carrier gas is, for example, the above-described inert gases, and may be nitrogen or a mixture thereof with oxygen gas or hydrogen gas.

The flow rate of the carrier gas may be not less than 0.05 m/min and not more than 1.0 m/min, or may be not less than 0.32 m/min and not more than 0.64 m/min. Setting the flow rate of the carrier gas within the above range makes it possible to obtain a carbon layer made of graphene having an average number of layers of 4 or less. An amount of the organic compound to be introduced may be not less than 1 vol % and not more than 30 vol % or not less than 5 vol % and not more than 20 vol % with respect to a total amount of the carrier gas and the organic compound.

As a method for coating the particles with the carbon layer, an organic compound may be introduced by a wet method such as an impregnation method and carbonized. Before introducing the organic compound and performing CVD, the organic compound may be impregnated and carbonized. As the organic compound to be impregnated, for example, a thermally polymerizable monomer such as furfuryl alcohol having a high carbonization yield can be used. As a method for impregnating the particles with the organic compound, there can be employed known means such as bringing the particles into contact with the organic compound as it is or in a state in which the organic compound is mixed with a solvent when the organic compound is a liquid, or dissolved in a solvent when the organic compound is a solid.

After the first step, the carbon-coated particles may be subjected to a heat treatment to carbonize the carbon layer, and highly crystalline carbon may be deposited on the surfaces of the particles. The resulting carbon material (a) thus has higher crystallinity and a higher specific surface area.

Since the carbonization of the carbon layer can also proceed by the CVD treatment, the heat treatment may be performed at the time of the CVD treatment or may be performed by another method.

The heat treatment method is not particularly limited, and the heat treatment may be performed using a high-frequency induction heating furnace or the like.

### [Second Step]

The step of dissolving and removing the template, which is the second step, is a step of dissolving and removing the template from the carbon-coated particles to obtain a shell-shaped body.

For dissolving and removing the template, for example, an alkali solution such as NaOH, KOH, LiOH, RbOH, or CsOH may be used. For example, an alkali solution having a concentration of from 1 to 5 M may be used for the alkaline solution. The alkali solution may be 30 times or more, or 50 times or more of the stoichiometric ratio with respect to the particles. When the ratio is 30 times or more of the stoichiometric ratio, it is possible to reduce the remaining of particles serving as a template. At the time of dissolution and removal, for example, the carbon-coated particles may be placed in the alkali solution and subjected to a heat treatment at a heat treatment temperature of not less than 200° C. and not more than 300° C. At this time, for the purpose of bringing the alkaline solution into uniform contact with a sample, the sample of the carbon-coated particles may be pulverized in advance. The rate of temperature increase during the heat treatment is not particularly limited, and is, for example, from 200 to 300° C./hour. The heat treatment time (holding time at a predetermined heat treatment temperature) is not particularly limited and is, for example, not less than 1 hour and not more than 5 hours. The step of dissolution and removal may be performed plural times. The product can be analyzed and conditions required for sufficient template removal can be set based on the analysis results.

After dissolving and removing the template, for example, the shell-shaped body may be recovered by filtration or may be dried by vacuum heating. Vacuum heating drying conditions are not particularly limited, and, for example, a vacuum heating drying temperature can be set to not less than 100° C. and not more than 200° C. A vacuum heating drying time can be, for example, not less than 1 hour and not more than 10 hours.

Performing the method including the first step and the second step makes it possible to obtain a first shell-shaped body that is a hollow particle having one hole, and a second shell-shaped body that has a shape in which hollow particles are connected and has a plurality of pores, that is, the carbon material (a).

### [Third Step]

The method for producing the carbon material (a) may include a third step of performing heat treatment after the second step. Through the third step after the second step, the crystallinity of the coating carbon is enhanced and stabilized. Thus, the carbon material (a) (graphene) has higher levels of conductivity, corrosion resistance, and high specific surface area.

The heat treatment temperature is not particularly limited, and it may be not less than 1100° C. and not more than 1850° C., or not less than 1550° C. and not more than 1830° C. When the heat treatment temperature is 1100° C. or more, the effect of the present disclosure can be more remarkably obtained. When the temperature is 1850° C. or lower, it is possible to prevent the remaining template from reacting with carbon.

The heat treatment time (holding time at a predetermined heat treatment temperature) may be not less than 0.1 hours and not more than 10 hours, not less than 0.2 hours and not more than 5 hours, or not less than 0.5 hours and not more than 2 hours. The heat treatment step may be performed under reduced pressure.

[Method for Producing Carbon Material (b)]

The carbon material (b) can be produced, for example, by a method of coating inorganic particles with a carbon layer.

### (Inorganic Particle)

The inorganic particles include the inorganic particles described in the above section [Inorganic Particle]. The inorganic particles, when coated with a carbon layer by a CVD treatment or the like, may stably maintain its original structure during the CVD treatment or the like. Thus, they may have good heat resistance.

The inorganic particles may be a material having a uniform structure and composition with uniform particle sizes. In addition, to obtain a high specific surface area, a material capable of controlling the average number of layers of graphene to be obtained to 4 or less may be used. From such a viewpoint, the inorganic particles may be at least one selected from alumina, silica, magnesium oxide, tungsten carbide, aluminum nitride, and magnetic bodies such as magnetic metals, magnetic metal alloys, and magnetic oxides. In addition, from the viewpoint of improving electrical insulation performance, alumina or silica may be used, and, from the viewpoint of improving the thermal conductivity and the heat dissipation property, a magnetic body may be used, or at least one selected from Fe—Si—Al alloys (sendust), ferrite, and magnetite may be used.

The average particle diameter of the inorganic particles is not particularly limited, and the average particle diameter may be not less than 0.0005 μm and not more than 100 μm, not less than 0.1 μm and not more than 50 μm, or not less than 0.5 μm and not more than 20 μm. An average particle diameter of 0.0005 μm or more results in easy handling and good carbon coating properties. In addition, gas permeability of a carbon source is improved when the carbon source is coated, and thus uniform carbon coating is facilitated. On the other hand, when the average particle diameter is 100 μm or less, a carbon material (b) having a high specific surface area (BET specific surface area) can be obtained.

The inorganic particles may be used in admixture with a particulate spacer. Using the spacer makes it possible to secure an appropriate gap between the particles, and to reduce pressure loss due to excessively dense packing of the particles. The spacer may be a particle having an average particle diameter of, for example, not less than 100 μm and not more than 5000 μm. The material for the spacer is not particularly limited as long as it can be sieved after carbon coating, and it may be a material that does not decompose at not less than 900° C. and not more than 1000° C.

The blending ratio between the particles and the spacer is not particularly limited, and it may be, for example, from 0.1:10 to 10:10 or from 1:10 to 10:10 in terms of a mass ratio of (particles:spacer). When the blending ratio is within this range, the carbon material (b) may be obtained at a high yield.

(Coating with Carbon Layer)

The method for coating surfaces of the inorganic particles with the carbon layer is not particularly limited, and either of a wet method and a dry method can be applied. In addition, using a chemical vapor deposition (CVD) method or a method in which naphthalene molecules are introduced onto the surfaces of inorganic particles such as silica by chemical modification and then fired makes it possible to obtain a carbon layer made of graphene having an average number of layers of 4 or less.

The CVD method used for introducing the organic compound and depositing the carbon layer on the inorganic particles is as described in the section of [Method for Producing Carbon Material (a)].

The carbon-coated inorganic particles may be subjected to a heat treatment to carbonize the carbon layer, and highly crystalline carbon may be deposited on the surfaces of the inorganic particles. The resulting carbon material (b) thus has higher crystallinity and a higher specific surface area.

Since the carbonization of the carbon layer can also proceed by the CVD treatment, the heat treatment may be performed at the time of the CVD treatment or may be performed by another method.

The heat treatment method is not particularly limited, and the heat treatment may be performed using a high-frequency induction heating furnace or the like.

Performing the above-described method makes it possible to obtain core-shell particles in which the surfaces of inorganic particles are coated with a carbon layer and core-shell connected bodies in which the surfaces of connected bodies of inorganic particles are coated with a carbon layer, that is, the carbon material (b).

The composite material of the present disclosure may include the carbon material attached to the surface of the cellulose nanofiber from the viewpoint of exhibiting anisotropy of electromagnetic wave absorption performance, or may be a composite material obtained by dispersing the carbon material in the cellulose nanofiber from the viewpoint of improving electrical insulation properties.

In addition, changing the blending ratio of the cellulose nanofiber and the carbon material makes it possible to widely control the electrical characteristics of the composite material from good conductivity to insulation properties.

The content of the carbon material contained in the composite material of the present disclosure may be not less than 5 mass % and not more than 95 mass %, not less than 10 mass % and not more than 80 mass %, or not less than 20 mass % and not more than 65 mass % with respect to the total amount of the composite material. The composite material obtained when the content of the carbon material is 5 mass % or more can be used as an electromagnetic wave interference suppression material, and the composite material obtained when the content of the carbon material is 95 mass % or less can have a honeycomb structure.

When the composite material alone is used as the electromagnetic interference suppression material, the content of the carbon material contained in the composite material may be not less than 5 mass % and not more than 50 mass % with respect to the total amount of the composite material. When the content is within this range, insulation properties are exhibited. When the composite material is formed into a composite and then used as an electromagnetic interference suppression material, the content of the carbon material contained in the composite material may be not less than 5 mass % and not more than 95 mass % with respect to the total amount of the composite material. When the composite material is included in the composite, insulation properties are exhibited even in this range. When the composite material alone is used as a conductive material, the content of the carbon material contained in the composite material may be more than 50 mass % and not more than 95 mass % with respect to the total amount of the composite material. When the content is within this range, conductivity is exhibited.

### <Method for Producing Composite Material>

The method for producing the composite material of the present disclosure is not particularly limited.

### [Production Method-1]

When the composite material of the present disclosure includes the carbon material attached to the surface of the cellulose nanofiber, examples of the method for producing the composite material include a method of impregnating a honeycomb structure including the cellulose nanofiber with a dispersion containing a carbon material that is at least one selected from a carbon material (a) and a carbon material (b), the carbon material (a) including at least one selected from a first shell-shaped body and a second shell-shaped body, the first shell-shaped body including a hollow particle having one pore, and the second shell-shaped body having a shape in which hollow particles are connected and having a plurality of pores, and the carbon material (b) including at least one selected from a core-shell particle in which a surface of an inorganic particle is coated with a carbon layer and a core-shell connected body in which a surface of a connected body of inorganic particles is coated with a carbon layer.

The method for obtaining the honeycomb structure containing the cellulose nanofiber is not particularly limited, and examples thereof include an ice crystal template method. The ice crystal template method is a one-way freezing method, and is a method of controlling the growth of ice serving as a template. When the dispersion is frozen, a phase separation occurs, and the phase is divided into two phases of a phase in which almost pure water is solidified and a phase in which colloidal particles are concentrated. This concentration causes the colloidal particles gathered in the gaps of the ice to bond to each other even at an extremely low temperature of −196° C. At this time, the ice serves as a template, and the shape at the time of freezing is kept after drying.

The ice crystal template method may be performed by, for example, a procedure of preparing an aqueous dispersion, freezing, and freeze-drying.

### (Preparation of Aqueous Dispersion)

First, a raw material cellulose nanofiber is added to water and mixed to obtain an aqueous dispersion in which the cellulose nanofiber is dispersed in water.

As the cellulose nanofiber, those described in the section of <Composite Material> can be used. As the raw material, a resin other than the cellulose nanofiber may be further used. Examples of the resin other than the cellulose nanofiber include polyurethane. When polyurethane is used as the resin other than the cellulose nanofiber, the flexibility of the obtained honeycomb structure improves.

When a resin other than the cellulose nanofiber is contained as the raw material, a blending ratio [(Y):(X)] between the cellulose nanofiber (X) and the resin (Y) other than the cellulose nanofiber may be from 1:9 to 9:1 or from 1:4 to 4:1 on a mass basis.

The aqueous dispersion can be prepared by sufficient stirring manually or with a stirrer. The solid content concentration of the aqueous dispersion may be not less than 0.5 mass % and not more than 10 mass %, not less than 0.8 mass % and not more than 8 mass %, or not less than 1 mass % and not more than 6 mass %, based on the total amount (100 mass %) of the aqueous dispersion.

In the present disclosure, the “solid content concentration” refers to the content (concentration) of components other than the solvent.

The aqueous dispersion may be allowed to stand at not less than 0° C. and not more than 50° C. for not less than 1 minute and not more than 10 hours.

### (Freezing)

Then, the aqueous dispersion is transferred to a tubular cell and frozen.

The freezing of the aqueous dispersion may be performed by gradually inserting the entire cell into a coolant such as liquid nitrogen at a predetermined insertion speed using a constant-speed motor or the like. Inserting the aqueous dispersion into the coolant causes the ice in the portion inserted into the coolant to grow in a columnar shape along the insertion direction.

Changing the freezing condition makes it possible to change the diameter of the ice column serving as the template, and the honeycomb pore diameter of the obtained honeycomb structure can be appropriately adjusted.

The freezing temperature may be not less than −196° C. and not more than −10° C., not less than-196° C. and not more than −50° C., or not less than −196° C. and not more than −100° C. The insertion speed of the cell into the coolant may be not less than 2.5 cm/h and not more than 50 cm/h, not less than 5 cm/h and not more than 40 cm/h, or not less than 7.5 cm/h and not more than 30 cm/h.

### (Freeze-Drying)

Next, the frozen aqueous dispersion is freeze-dried. Sublimating water (ice) under reduced pressure (vacuum) in the freeze-drying makes it possible to obtain a honeycomb structure containing a cellulose nanofiber.

The freeze-drying may be performed using a vacuum freeze-dryer. The freeze-drying may be performed, for example, under a condition of not less than −20° C. and not more than 30° C. for 24 hours or more. The upper limit of the freeze-drying time is not particularly set, and it may be 72 hours or less.

### (Impregnation)

Next, the obtained honeycomb structure containing the cellulose nanofiber is impregnated with the dispersion liquid containing the carbon material. This makes it possible to obtain a composite material in which the carbon material is attached to the inner wall and the outer wall of the honeycomb pore of the honeycomb structure containing the cellulose nanofiber.

As the carbon material, those described in the section of <Composite Material> can be used. Examples of the solvent for dispersing the carbon material include water and ethanol. The solid content concentration of the dispersion may be not less than 0.5 mass % and not more than 10 mass %, not less than 0.8 mass % and not more than 8 mass %, or not less than 1 mass % and not more than 6 mass %, based on the total amount (100 mass %) of the dispersion.

The impregnation of the honeycomb structure with the dispersion containing the carbon material may be performed, for example, under a condition of not less than 0° C. and not more than 50° C. for 1 minute or more. The upper limit of the impregnation time is not particularly set, and it may be 72 hours or less.

### [Production Method-2]

When the composite material of the present disclosure is obtained by dispersing the carbon material in the cellulose nanofiber, examples of the method for producing the composite material include a method of mixing, with an aqueous dispersion containing the cellulose nanofiber, a carbon material that is at least one selected from a carbon material (a) and a carbon material (b), the carbon material (a) including at least one selected from a first shell-shaped body and a second shell-shaped body, the first shell-shaped body including a hollow particle having one pore, and the second shell-shaped body having a shape in which hollow particles are connected and having a plurality of pores, and the carbon material (b) including at least one selected from a core-shell particle in which a surface of an inorganic particle is coated with a carbon layer and a core-shell connected body in which a surface of a connected body of inorganic particles is coated with a carbon layer, and freezing the mixture.

As the carbon material and the cellulose nanofiber, those described in the section of <Composite Material> can be used.

Examples of the method for freezing the aqueous dispersion include the ice crystal template method described above.

### (Preparation of Aqueous Dispersion)

First, a raw material cellulose nanofiber is added to water and mixed to obtain an aqueous dispersion in which the cellulose nanofiber is dispersed in water.

As the raw material, a resin other than the cellulose nanofiber may be further used. Examples of the resin other than the cellulose nanofiber can include those listed in [Production Method-1]. When a resin other than the cellulose nanofiber is contained as the raw material, the blending amount thereof is as described in [Production Method-1].

Next, a carbon material is added to and mixed with the aqueous dispersion to obtain an aqueous dispersion in which a cellulose nanofiber, a resin other than the cellulose nanofiber to be blended as necessary, and the carbon material are dispersed.

The aqueous dispersion can be prepared by sufficient stirring manually or with a stirrer. The solid content concentration of the aqueous dispersion may be not less than 0.5 mass % and not more than 10 mass %, not less than 0.8 mass % and not more than 8 mass %, or not less than 1 mass % and not more than 6 mass %, based on the total amount (100 mass %) of the aqueous dispersion.

The aqueous dispersion may be allowed to stand at not less than 0° C. and not more than 50° C. for 1 minute or more. The upper limit of the time for allowing the aqueous dispersion to stand is not particularly provided, and it may be 72 hours or less.

### (Freezing)

Then, the aqueous dispersion is transferred to a tubular cell and frozen.

The freezing of the aqueous dispersion may be performed by gradually inserting the entire cell into a coolant such as liquid nitrogen at a predetermined insertion speed using a constant-speed motor or the like. Inserting the aqueous dispersion into the coolant causes the ice in the portion inserted into the coolant to grow in a columnar shape along the insertion direction.

Changing the freezing condition makes it possible to change the diameter of the ice column serving as the template, and the honeycomb pore diameter of the obtained honeycomb structure can be appropriately adjusted.

The freezing temperature may be not less than −196° C. and not more than −10° C., not less than-196° C. and not more than −50° C., or not less than −196° C. and not more than −100° C. The insertion speed of the cell into the coolant may be not less than 2.5 cm/h and not more than 50 cm/h, not less than 5 cm/h and not more than 40 cm/h, or not less than 7.5 cm/h and not more than 30 cm/h.

### (Freeze-Drying)

Next, the frozen aqueous dispersion is freeze-dried. Sublimating water (ice) under reduced pressure (vacuum) in the freeze-drying makes it possible to obtain a honeycomb structure obtained by dispersing a carbon material in a cellulose nanofiber.

The freeze-drying may be performed using a vacuum freeze-dryer. The freeze-drying may be performed, for example, under a condition of not less than −10° C. and not more than 50° C. for 1 minute or more. The upper limit of the freeze-drying time is not particularly set, and it may be 72 hours or less.

### (Annealing Treatment)

The honeycomb structure may be subjected to annealing treatment. Performing annealing treatment on the honeycomb structure makes it possible to improve the mechanical strength and improve the water resistance. The annealing treatment may be performed, for example, at not less than 60° C. and not more than 250° C. for not less than 1 hour and not more than 24 hour, or at not less than 100° C. and not more than 250° C. for not less than 1 hour and not more than 10 hours.

The composite material thus obtained, having a honeycomb structure including a cellulose nanofiber and a carbon material having a specific structure, improves at least one of anisotropy, electromagnetic wave absorbability, weight reduction, and insulation properties. In addition, the composite material can be used as an electromagnetic interference suppression material because the composite material has performance of further reducing electromagnetic interference.

### <Composite>

The composite of the present disclosure includes the above-described composite material and at least one selected from an organic substance and an inorganic substance. When the composite of the present disclosure includes the above-described composite material, at least one of anisotropy, electromagnetic wave absorbability, weight reduction, and insulation properties improves. In addition, the composite can be used as an electromagnetic interference suppression material because the composite has performance of further reducing electromagnetic interference.

As the composite material, those described in the section of <Composite Material> are used.

The composite material may be used as it is, or may be used after it is, for example, cooled and solidified, ground to an appropriate size using a cutting mill, a ball mill, a cyclone mill, a hammer mill, a vibration mill, a cutter mill, a grinder mill, a speed mill, or the like.

The content of the composite material may be not less than 0.05 mass % and not more than 50 mass %, not less than 0.08 mass % and not more than 30 mass %, or not less than 0.10 mass % and not more than 20 mass % with respect to the total amount of the composite from the viewpoint of further exhibiting the effect of the present disclosure.

### (Organic Substance)

The organic substance used in the present disclosure is not particularly limited, and examples thereof include a thermosetting resin and a thermoplastic resin. Examples of the thermosetting resins include epoxy resins, phenolic resins, and imide resins. Examples of the thermoplastic resins include polyamide resins and polycarbonates.

The organic substance may be a thermosetting resin from the viewpoint of the reliability of the molded body using the composite, and may be an epoxy resin or an imide resin from the viewpoint that the molded body using the composite further exhibits the effect of the present disclosure.

One type of the organic substance may be used, or two or more types may be used in combination.

In the present disclosure, the epoxy resin used as the organic substance has two or more epoxy groups per molecule, and the molecular structure, molecular weight, and the like are not particularly limited as long as the epoxy resin is one that is commonly used in electronic components.

Examples of the epoxy resin include aliphatic epoxy resins, such as phenol novolac-type epoxy resins, cresol novolac-type epoxy resins, and dicyclopentadiene derivatives; and aromatic epoxy resins, such as biphenyl-type, biphenyl aralkyl-type, naphthyl-type, and bisphenol-type epoxy resins. One type of these epoxy resins may be used, or two or more may be mixed and used. The properties of the epoxy resin are also not particularly limited, and the epoxy resin may be either a liquid or a solid at ambient temperature (25° C.). For example, the epoxy resin may be a solid cresol novolac-type epoxy resin. The solid cresol novolac-type epoxy resin can be obtained as a commercially available product, and examples thereof include N670 (available from DIC Corporation). Further, for example, the epoxy resin may be a liquid epoxy resin. Specific examples thereof include a bisphenol A-type epoxy resin and a bisphenol F-type epoxy resin, and it may be a liquid bisphenol A-type epoxy resin. The liquid bisphenol A-type epoxy resin can be obtained as a commercially available product, and examples thereof include EPOMIK (trade name) R140 (available from Mitsui Chemicals, Inc.).

In the present disclosure, the liquid epoxy resin refers to an epoxy resin that is in a liquid form at 25° C.

An epoxy equivalent weight of the epoxy resin may be 140 or more from the viewpoint of thermal mechanical properties of the molded body using the composite. The epoxy equivalent weight may be 200 or more from the viewpoint of further exhibiting the effect of the present disclosure. The upper limit value of the epoxy equivalent weight may be 400 or less, or may be 380 or less from the viewpoint of the thermal mechanical properties.

The epoxy resin may include a polyoxyalkylene structure represented by (R¹O)m and a polyoxyalkylene structure represented by (R²O)n.

Here, R¹ and R² each independently represent an alkylene group having one or more carbons. m+n may be from 1 to 50, or may be from 1 to 20. m may be from 0 to 49, or may be from 0 to 19. n may be from 1 to 50, or may be from 1 to 20.

Examples of the alkylene groups represented by R¹ and R² include an alkylene group having 1 to 6 carbons, and specifically include a methylene group, an ethylene group, a trimethylene group, a propylene group, a tetramethylene group, and a hexamethylene group. From the viewpoint of further exhibiting the effect of the present disclosure, each of the alkylene groups may be a methylene group or an ethylene group.

Of the quantity m of the R¹O groups, the plurality of R¹ may all be the same alkylene group, or may be alkylene groups with different numbers of carbons. Of the quantity n of the R²O groups, the plurality of R² may all be the same alkylene group, or may be alkylene groups with different numbers of carbons.

Examples of the epoxy resin including the polyoxyalkylene structure include liquid epoxy resins including a bisphenol A skeleton, and polyethylene glycol diglycidyl ether. Examples of a commercially available product of the liquid epoxy resin including the bisphenol A skeleton include Rikaresin BEO-60E (available from New Japan Chemical Co., Ltd.) expressed by the following General Formula (1). Examples of a commercially available product of the polyethylene glycol diglycidyl ether include Epolite 400E (available from Kyoeisha Chemical Co., Ltd.), which contains a compound represented by the following general formula (2) as a main component.

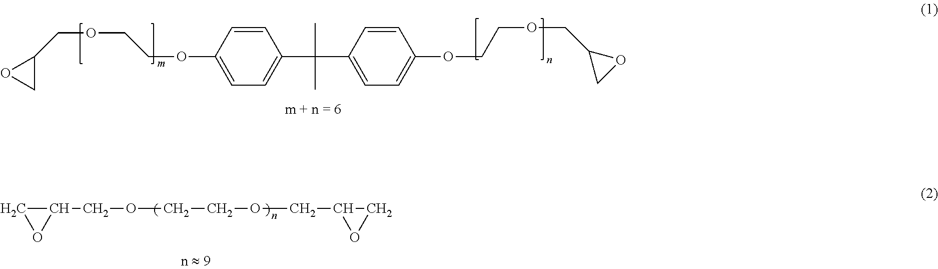

In the present disclosure, examples of the imide resin used as the organic substance include bis-allyl nadi-imide. Bis-allyl nadi-imide can be obtained as a commercially available product, and examples thereof include BANI-M (available from Maruzen Petrochemical Co., Ltd.) and BANI-X (available from Maruzen Petrochemical Co., Ltd.).

When the composite of the present disclosure contains the organic substance, the content thereof may be not less than 1 mass % and not more than 40 mass %, not less than 3 mass % and not more than 30 mass %, not less than 4 mass % and not more than 25 mass %, or not less than 5 mass % and not more than 20 mass % with respect to the total amount of the composite from the viewpoint of further exhibiting the effect of the present disclosure.

When a thermosetting resin is contained as the organic substance, the composite of the present disclosure may further contain a curing agent, a curing accelerator, and the like. Examples of the curing agent include aliphatic amines, aromatic amines, dicyandiamides, dihydrazide compounds, acid anhydrides, and phenolic resins. One type of these may be used, or two or more types may be used in combination.

Examples of the curing accelerator include organic peroxides such as dicumyl peroxide and dibutyl peroxide; imidazole compounds such as 2-methylimidazole and 2-ethylimidazole; organophosphorus-based compounds such as trimethylphosphine, triethylphosphine, tributylphosphine and triphenylphosphine; diazabicycloalkene compounds such as 1,8-diazabicyclo[5,4,0]undecene-7 (DBU) and 1,5-diazabicyclo(4,3,0)nonene-5; and tetraphenylboron-based compounds such as 2-ethyl-4-methylimidazole tetraphenylborate. One type of these may be used, or two or more types may be used in combination.

When the composite of the present disclosure contains a curing agent, the content of the curing agent with respect to the total amount of the composite may be not less than 1.0 mass % and not more than 20.0 mass %, may be not less than 2.0 mass % and not more than 18.0 mass %, or may be not less than 3.0 mass % and not more than 15.0 mass %.

When the composite of the present disclosure contains a curing accelerator, the content thereof with respect to the total amount of the composite may be not less than 0.01 mass % and not more than 10.0 mass %, may be not less than 0.05 mass % and not more than 5.0 mass %, or may be not less than 0.1 mass % and not more than 3.0 mass %.

### (Inorganic Substance)

The inorganic substance used in the present disclosure is not particularly limited as long as it is an inorganic substance used in an electronic component. Examples of the inorganic substance include silica, alumina, magnesium oxide, titanium oxide, barium titanate, silicon nitride, aluminum nitride, silicon carbide, tungsten carbide, and ceramics.

Specific examples of the ceramics include, but are not limited to, sintered bodies containing a metal oxide, nitride, carbide, or the like as a main component. Specific examples of the metal oxide include alumina, zirconia, and magnesium oxide. Specific examples of the metal nitride include aluminum nitride, boron nitride, and silicon nitride. Specific examples of the metal carbide include silicon carbide and boron carbide.

The ceramics may be at least one sintered body selected from alumina and aluminum nitride.

The inorganic substance may be at least one selected from silica, alumina, and silicon carbide, and may be silica from the viewpoint of further exhibiting the effect of the present disclosure.

The shape of the inorganic substance is not particularly limited, and examples thereof include a powder shape, a fiber shape, and a scale shape. The shape of the inorganic substance may be a powder shape or a spherical shape.

An average particle diameter of the inorganic substance is not particularly limited, and it may be not less than 0.1 μm and not more than 100 μm, not less than 0.2 μm and not more than 75 μm, or not less than 0.2 μm and not more than 50 μm.

In the present specification, the average particle diameter is the volume average particle diameter, and the average particle size of the inorganic substance can be calculated as an average value of the long diameter of the particles, measured using a laser diffraction-type device for measuring the particle size distribution.

When the composite of the present disclosure contains the inorganic substance, the content thereof may be not less than 30 mass % and not more than 95 mass %, not less than 40 mass % and not more than 90 mass %, or not less than 50 mass % and not more than 88 mass % with respect to the total amount of the composite from the viewpoint of further exhibiting the effect of the present disclosure.

### (Other Component)

In addition to each of the components described above, the composite of the present disclosure can be blended, as necessary, with additives generally blended in this type of composite without departing from the gist of the present disclosure, and examples of the additives include release agents, such as synthetic waxes, natural waxes, higher fatty acids, and esters of higher fatty acids; colorants, such as cobalt blue; modifiers, such as silicone oil or silicone rubber; hydrotalcites; ion scavengers; electrostatic charge-controlling agents; and flame retardants such as phosphazene. One type of these additives may be used, or two or more types may be mixed and used.

The content of each of these additives in the composite of the present disclosure may be not less than 0.05 mass % and not more than 30.0 mass %, or not less than 0.2 mass % and not more than 20.0 mass % as the total amount of the additives with respect to the total amount of the composite.

In the composite of the present disclosure, the total content of the composite material, the organic substance, and the inorganic substance may be 70 mass % or more, or may be 80 mass % or more.

### [Method for Producing Composite]

The composite of the present disclosure may be obtained by sufficiently and uniformly mixing a composite material having a honeycomb structure containing a cellulose nanofiber and a carbon material, at least one selected from an organic substance and an inorganic substance, and an additive to be blended as necessary with a mixer or the like, and then performing a kneading treatment with a disperser, a kneader, a three-roll mill, a biaxial heating roll, a biaxial heating extrusion kneader or the like. The kneading treatment may be performed with heating. The temperature when heating may be not less than 70° C. and not more than 150° C. or not less than 75° C. and not more than 120° C.

After the kneading treatment, the composite of the present disclosure may be, for example, cooled and solidified, ground to an appropriate size using a cutting mill, a ball mill, a cyclone mill, a hammer mill, a vibration mill, a cutter mill, a grinder mill, a speed mill, or the like, and then used.

The mixture obtained after the kneading treatment may be pressed and molded into a sheet shape in a molding machine at a temperature of not less than 50° C. and not more than 100° C. and a pressure of not less than 0.5 MPa and not more than 1.5 MPa.

### [Physical Properties of Composite]

From the viewpoint of preventing transmission signal loss when a molded body of the composite of the present disclosure is present on a transmission line of an electronic component, the real part (ε′) of the complex dielectric constant at 25° C. and 10 GHz may be 30 or less, 25 or less, or 20 or less. The lower limit of the s′ is not particularly set, but it may be 2 or more.

From the viewpoint of electromagnetic wave absorption performance, the molded body of the composite of the present disclosure may have an imaginary part (ε″) of a complex dielectric constant at 25° C. and 10 GHz of 0.5 or more, 0.8 or more, or 1.0 or more. The upper limit of ε″ is not particularly limited, and it may be 30 or less.

The ε′ and the ε″ can be measured in accordance with a waveguide method, and specifically, the ε′ and the ε″ can be measured by the method described in Examples.

The electromagnetic wave absorption performance of the molded body of the composite of the present disclosure may be −2 dB or less, may be −4 dB or less, or may be −6 dB less.

The electromagnetic wave absorption performance is a value obtained as follows. A molded body having a thickness of 0.5 mm and prepared through compression molding is installed between a high-frequency oscillating device and a reception antenna. The electromagnetic wave intensity when electromagnetic waves having a measurement frequency of 10 GHz are generated is measured for both a case in which the molded body is present and a case in which the molded body is not present. A ratio of the electromagnetic wave intensities of both cases ((electromagnetic wave intensity when electromagnetic waves are absorbed by the molded body)/(electromagnetic wave intensity when the molded body is not present)) is then expressed in units of dB.

The electromagnetic wave intensity can be measured in accordance with the “IEICE Transactions on Fundamentals of Electronics, Communications, and Computer Sciences B, Vol. J97-B, No. 3, pp. 279-285”.

The molded body of the composite of the present disclosure may have a volume resistivity of 1.0×10⁶ Ω·cm or more, or 1.0×10⁸ Ω·cm or more. The upper limit is not particularly defined, but it may be 1.0×10¹⁶ Ω·cm or less.

The volume resistivity can be measured in accordance with JIS K-6911:2006, and specifically, the volume resistivity can be measured by the method described in Examples.

The composite of the present disclosure can be used as an electromagnetic wave absorbing material, an electromagnetic wave absorbing sheet, a semiconductor sealing material, a sealing sheet, a coating material of an electric wire, a transparent electrode, a coating material, a paint, or the like.

### EXAMPLES

The present disclosure will be specifically described through examples; however, the present disclosure is not limited in any way to these examples.

### Production Example 1: Production of Carbon Material

### (Production of Carbon-Coated Alumina Nanoparticle)

Alumina nanoparticles (TM300 available from Taimei Chemicals Co., Ltd., crystal phase: γ-alumina, average particle diameter: 7 nm, specific surface area: 220 m²/g) and silica sand as a spacer (available from SendaiWako Pure Chemical, Ltd.) were mixed at a mass ratio of 3:20 (alumina nanoparticles:silica sand). The silica sand used was silica sand soaked in 1 M hydrochloride for 12 hours, heated at 800° C. for 2 hours in air in a muffle oven, and sieved at intervals of 180 μm. The mixture of alumina nanoparticles and silica sand prepared above was placed in a reaction tube (internal diameter: 37 mm), and CVD using methane as a carbon source (methane CVD) was performed.

In the methane CVD, under the condition that the flow rate of N₂ gas was adjusted to 224 ml/min, the alumina nanoparticles were heated from room temperature (20° C.) to 900° C. at a rate of temperature increase of 10° C./min and held at 900° C. for 30 minutes. Thereafter, N₂ gas was used as a carrier gas, methane was introduced into the reaction tube in an amount of 20 vol % with respect to the total amount of the carrier gas and methane, and a chemical vapor deposition (CVD) treatment was performed at 900° C. for 2 hours. At this time, the flow rates of the methane gas and the N₂ gas were adjusted to 45 ml/min and 179 ml/min, respectively. Thereafter, the introduction of the methane gas was stopped, and under the condition that the flow rate of the N₂ gas was adjusted to 224 ml/min, the alumina nanoparticles were held at 900° C. for 30 minutes and then cooled to obtain carbon-coated alumina nanoparticles 1.

### (Dissolution and Removal of Template)

The carbon-coated alumina nanoparticles 1 and 5 M NaOH (50 times or more of the stoichiometric ratio) were placed in an autoclave vessel made of Teflon (trade name), heated at a rate of temperature increase of 250° C./hour using a muffle furnace, and held at 250° C. for 2 hours. Thereafter, the obtained material was naturally cooled, recovered by filtration, and dried by vacuum heating at 150° C. for 6 hours to obtain a carbon material 1 (shell-shaped body).

### [Measurement Evaluation of Carbon Material]

The obtained carbon material 1 was subjected to measurement evaluation for the following items. The measurement evaluation results are summarized in Table 1.

### <Specific Surface Area (BET Specific Surface Area)>

The obtained carbon material 1 was dried by vacuum heating at 150° C. for 6 hours, and then the specific surface area (m²/g) was determined by a multipoint method from a nitrogen adsorption isotherm measured using a high-precision automatic gas/vapor adsorption amount measuring device “BEL SORP MAX” (available from Bel Japan, Inc.).

### <Average Number of Layers of Graphene>

From the specific surface area determined by the above-described method, the average number of layers of graphene was determined by the following formula.

$$Average number of layers of graphene = 2627 ( {m}^{2} / g ) / specific surface area ( {m}^{2} / g )$$

### <Pore Volume>

The obtained carbon material 1 was dried by vacuum heating at 150° C. for 6 hours, and then subjected to nitrogen adsorption isotherm measurement using a high-precision automatic gas/vapor adsorption amount measuring device “BEL SORP MAX” (available from Bel Japan, Inc.) to determine the pore volume per material mass (cc/g) from the adsorption amount at a relative pressure (P/P0) of 0.96.

TABLE 1

| | | Average | |
|---|---|---|---|
| | BET specific | number of | |
| | surface area | layers of | Pore volume |
| | [m²/g] | graphene | [cc/g] |
| Carbon | 1690 | 1.6 | 2.7 |
| material 1 | | | |

### Production Example 2: Production of TEMPO Oxidized Cellulose Nanofiber

Needle bleached kraft pulp (NBKP, containing 12 g of cellulose) was added to 700 ml of deionized water, and the mixture was stirred using a simple stirrer (K-2RN, manufactured by AS ONE Corporation) at a rotation speed of 300 rpm for 20 minutes. To the obtained NBKP aqueous solution, 20 ml of an aqueous solution containing 0.15 g of 2,2,6,6-tetramethylpiperidine-1-oxyl radical (TEMPO, available from Wako Pure Chemical Industries, Ltd.) and 20 ml of an aqueous solution containing 1.5 g of sodium bromide (available from KANTO CHEMICAL CO., INC.) were slowly added. An aqueous solution of sodium hypochlorite (available from Wako Pure Chemical Industries, Ltd.) prepared to have a Cl concentration of 8 mass % was slowly added to the obtained mixed liquid to start a TEMPO oxidation reaction. Subsequently, a 3M aqueous solution of sodium hydroxide (available from Wako Pure Chemical Industries, Ltd.) was added to the mixed liquid to adjust the pH to 10.5. The obtained TEMPO oxidized cellulose fiber was washed three times with 1200 ml of pure water to remove residual sodium hypochlorite, sodium hydroxide, and the like, whereby a wet paste having a concentration of 3 mass % was obtained. The obtained wet paste was treated with a blender (MX1000XTX, available from WARING) to break down bundles of oxidized cellulose fibers into nanofibers. This mechanical treatment was repeated several times with the addition of water to obtain a TEMPO oxidized cellulose nanofiber.

Using an atomic force microscope (AFM), 100 fibers of the obtained TEMPO oxidized cellulose nanofiber were observed, and the average value of fiber diameters and the average value of fiber lengths were calculated. As a result, the average fiber diameter was 5 nm, and the average fiber length was 1.25 μm.

### [Production of Composite Material]

### Example 1

The TEMPO-oxidized cellulose nanofiber produced in Production Example 2 was dispersed in water to prepare an aqueous dispersion having a solid content concentration of 3 mass %. An aqueous urethane resin (DAOTAN VTW 1265/36WA available from DAICEL-ALLNEX LTD.) was added to the aqueous dispersion so that the resin component was 3 mass % and the carbon material 1 produced in Production Example 1 was 2.6 mass %, and they were well mixed. Then, the mixture was transferred to a tubular cell, and the cell was inserted into a refrigerant at −196° C. at an insertion speed of 10 cm/h and frozen in one direction.

Then, after the cell was pulled up, the pressure was reduced at −5° C. for 24 hours and then further reduced at 0° C. for 24 hours by using a sealed chamber to perform freeze-drying, whereby a composite material 1 having a cylindrical honeycomb structure obtained by dispersing the carbon material 1 in the TEMPO oxidized cellulose nanofiber and urethane was obtained.

Then, the obtained composite material 1 was subjected to an annealing treatment at 200° C. for 6 hours. The composite material 1 after the annealing treatment was cut into 440 mm×440 mm×25 mm to obtain a sample for evaluation.

### Example 2

The TEMPO-oxidized cellulose nanofiber produced in Production Example 2 was dispersed in water to prepare an aqueous dispersion having a solid content concentration of 3 mass %. An aqueous urethane resin (DAOTAN VTW 1265/36WA available from DAICEL-ALLNEX LTD.) was added to the aqueous dispersion so that the resin component was 3 mass %, and they were well mixed. Then, the mixture was transferred to a tubular cell, and the cell was inserted into a refrigerant at −196° C. at an insertion speed of 10 cm/h and frozen in one direction.

Then, after the cell was pulled up, the pressure was reduced at −5° C. for 24 hours and then further reduced at 0° C. for 24 hours by using a sealed chamber to perform freeze-drying, whereby a cylindrical honeycomb structure including the TEMPO oxidized cellulose nanofiber and urethane was obtained.

Next, an aqueous dispersion having a solid content concentration of 2 mass % in which the carbon material 1 produced in Production Example 1 was dispersed in water was prepared, and the honeycomb structure was immersed in the aqueous dispersion at room temperature (20° C.) for 30 minutes, and then heated and dried at 120° C. for 120 minutes, whereby a composite material 2 in which the carbon material 1 was attached to the surface of the honeycomb structure was obtained. The obtained composite material 2 was cut into 440 mm×440 mm×25 mm to obtain a sample for evaluation.

### Example 3

The TEMPO-oxidized cellulose nanofiber produced in Production Example 2 was dispersed in water to prepare an aqueous dispersion having a solid content concentration of 3 mass %. An aqueous urethane resin (DAOTAN VTW 1265/36WA available from DAICEL-ALLNEX LTD.) was added to the aqueous dispersion so that the resin component was 3 mass % and the carbon-coated alumina nanoparticles 1 produced in Production Example 1 was 8.2 mass %, and they were well mixed. Then, the mixture was transferred to a tubular cell, and the cell was inserted into a refrigerant at −196° C. at an insertion speed of 10 cm/h and frozen in one direction. Then, after the cell was pulled up, the pressure was reduced at −5° C. for 24 hours and then further reduced at 0° C. for 24 hours by using a sealed chamber to perform freeze-drying, whereby a composite material 3 having a cylindrical honeycomb structure obtained by dispersing the carbon-coated alumina nanoparticles 1 in the TEMPO oxidized cellulose nanofiber and urethane was obtained.

Then, the obtained composite material 3 was subjected to an annealing treatment at 200° C. for 6 hours. The composite material 3 after the annealing treatment was cut into 440 mm×440 mm×25 mm to obtain a sample for evaluation.

### Example 4

The TEMPO-oxidized cellulose nanofiber produced in Production Example 2 was dispersed in water to prepare an aqueous dispersion having a solid content concentration of 3 mass %. An aqueous urethane resin (DAOTAN VTW 1265/36WA available from DAICEL-ALLNEX LTD.) was added to the aqueous dispersion so that the resin component was 3 mass %, and they were well mixed. Then, the mixture was transferred to a tubular cell, and the cell was inserted into a refrigerant at −196° C. at an insertion speed of 10 cm/h and frozen in one direction.

Then, after the cell was pulled up, the pressure was reduced at −5° C. for 24 hours and then further reduced at 0° C. for 24 hours by using a sealed chamber to perform freeze-drying, whereby a cylindrical honeycomb structure including the TEMPO oxidized cellulose nanofiber and urethane was obtained.

Next, an aqueous dispersion having a solid content concentration of 6 mass % in which the carbon-coated alumina nanoparticles 1 produced in Production Example 1 was dispersed in water was prepared, and the honeycomb structure was immersed in the aqueous dispersion at room temperature (20° C.) for 30 minutes, and then heated and dried at 120° C. for 120 minutes, whereby a composite material 4 in which the carbon-coated alumina nanoparticles 1 were attached to the surface of the honeycomb structure was obtained. The obtained composite material 4 was cut into 440 mm×440 mm×25 mm to obtain a sample for evaluation.

### Comparative Example 1

Adipic acid, diethylene glycol, and trimethylolpropane were placed in a flask, and heated and mixed at 120° C., triisopropyl titanate was added thereto, and the mixture was dehydrated at 240° C. under reduced pressure to prepare an adipic acid-based polyester polyol.

Ten parts by mass of the adipic acid-based polyesterpolyol, 70 parts by mass of a terephthalic acid-based polyesterpolyol “Terol 250” (available from OXID), 20 parts by mass of an ethylenediamine-based polyetherpolyol “AE-300” (available from Mitsui Chemicals, Inc.), 15 parts by mass of a flame retardant “TMCPP” (available from Daihachi Chemical Industry Co., Ltd.), 1 part by mass of a foam stabilizer “L-5340” (available from Nippon Unicar Co., Ltd.), 2.5 parts by mass of a catalytic agent “KL-31” (available from Kao Corporation), 35 parts by mass of a foaming agent “HFC-245fa” and 1.5 parts by mass of water were mixed to obtain a polyol mixture.

The obtained polyol mixture and isocyanate “SUMIDUR 44 V 20” (manufactured by Sumika Bayer Urethane Co., Ltd.) were prepared so that the urethane index was 105, and they were stirred and mixed. The obtained mixture was placed in a mold and molded into a size of 440 mm×440 mm×25 mm to obtain a rigid polyurethane foam (foamed polyurethane). Subsequently, the obtained rigid polyurethane foam was cut into a size of 440 mm×440 mm×25 mm.

Next, a mixed dispersion 1 was prepared by mixing 1 part by mass of carbon black (TPK1227R; Manufactured by Cabot Corporation, average particle diameter: 0.1 μm) with 10000 mL of a urethane-based emulsion “SUPERFLEX” (available from DKS Co., Ltd.), and the obtained foamed polyurethane was immersed in the mixed dispersion 1 at room temperature (20° C.) for 30 minutes, and then heated and dried at 120° C. for 120 minutes, whereby a composite material 5 in which a powder carbon material was present on the surface of the foamed polyurethane was obtained.

The obtained composite material 5 (440 mm×440 mm×25 mm) was used as a sample for evaluation.

### [Measurement Evaluation of Composite Material]

The obtained composite materials were subjected to measurement evaluation for the following items. The measurement evaluation results are summarized in Table 2.

### <Honeycomb Opening Diameter>

For the honeycomb pores of the honeycomb structure of the composite materials 1 to 4, an average value of opening diameters of 100 honeycomb pores observed in five fields of view was calculated and taken as the honeycomb opening diameter by using a scanning electron microscope (SEM).

### <Content or Attached Amount of Carbon Material>

The content of the carbon material contained in the composite materials obtained in Examples 1 and 3 was calculated from the charged amounts of the cellulose nanofiber, the urethane resin, and the carbon material. In addition, the attached amount of the carbon material attaching to the composite materials obtained in Examples 2 and 4 was calculated from the difference between the mass after impregnation of the honeycomb structure containing the cellulose nanofiber and the urethane with a dispersion containing the carbon material and the mass before impregnation of the honeycomb structure containing the cellulose nanofiber and the urethane. The attached amount of the carbon material attaching to the composite material obtained in Comparative Example 1 was calculated from the difference between the mass after the foamed polyurethane was impregnated into the dispersion containing the carbon material and the mass before the impregnation of the foamed polyurethane.

### <Electromagnetic Wave Absorption Performance (Frequency: 5 GHZ, Far Field Measurement System)>

A 1 mm thick copper plate (600 mm×600 mm) was placed on an antireflection radio wave absorber, and an evaluation sample (440 mm×440 mm×25 mm) was placed on a metallic plate. Next, an antenna was attached to a network analyzer via a cable, and electromagnetic waves having a frequency of 5 GHz were transmitted from one antenna, reflected by the evaluation sample and the metallic plate placed below the evaluation sample, and received by the other antenna to measure the electromagnetic wave intensity. In addition, electromagnetic waves were radiated in the same manner as described above to measure the electromagnetic wave intensity without placing the evaluation sample on the metallic plate. The ratio (electromagnetic wave intensity when electromagnetic waves were absorbed by the evaluation sample/electromagnetic wave intensity when the evaluation sample was not present) was defined as electromagnetic wave absorption performance in the units of dB. To evaluate the anisotropy of the electromagnetic wave absorption performance, the transmission angle of the electromagnetic wave was set to 2 levels of 10° close to perpendicular to the sample for evaluation and 45° from an oblique direction.

The electromagnetic wave intensity was measured in accordance with “Reports of Kagoshima Prefectural Institute of Industrial Technology, No. 15 (2001), pp 53-61”.

TABLE 2

| | | | Electromagnetic wave | |
|---|---|---|---|---|
| | | Content | absorption performance | |
| | | of carbon | 5 GHz [dB] | |
| | Honeycomb | material | Electro- | Electro- |
| | opening | (attached | magnetic | magnetic |
| | diameter | amount) | wave incident | wave incident |
| | [μm] | [mass %] | angle 10° | angle 45° |
| Example 1 | 50 | 30 | −10 | −2 |
| Example 2 | 50 | 30 | −8 | −2 |
| Example 3 | 50 | 95 | −9 | −2 |
| Example 4 | 50 | 95 | −8 | −3 |
| Comparative | — | 30 | −2 | −3 |
| Example 1 | | | | |

As shown in Table 2, Examples 1 to 4 using a composite material having a honeycomb structure containing a cellulose nanofiber and a carbon material having a specific structure had better electromagnetic wave absorption performance than a general urethane foaming type radio wave absorber, and had strong anisotropy in the electromagnetic wave absorption performance. In the composite material of the present disclosure, specific large absorption performance can be expected in a frequency region where the length of ½ wavelength of the electromagnetic wave matches the honeycomb opening diameter or the honeycomb opening circumferential diameter.

### [Production of Composite]

The details of the components listed in Table 3 used in the production of the composite are as follows.

### [Organic Substance]

Epoxy resin: EPICLON N670; cresol novolac-type epoxy resin; available from DIC Corporation, epoxy equivalent: 210

### [Inorganic Substance]

Silica: FB105; available from Denka Co., Ltd., average particle diameter: 12 μm

### [Carbon Material]

Composite material 1: Composite material produced in Example 1
Composite material 2: Composite material produced in Example 2
Composite material 3: Composite material produced in Example 3
Composite material 4: Composite material produced in Example 4
Cellulose nanofiber (CNF): TEMPO oxidized cellulose nanofiber produced in Production Example 2. Average fiber diameter: 5 nm, average fiber length: 1.25 μm
Carbon nanotube (CNT): LUCAN; available from LG; average fiber length: 30 μm, average fiber diameter: 0.02 μm

### [Other Component]

Curing agent: BRG-557; phenol novolac resin; available from Aica Kogyo Co., Ltd.
Curing accelerator: Curezol C11Z; imidazole compound; available from Shikoku Chemicals Corporation
Flame retardant: Rabitle (phosphazene-based flame retardant) FP100; available from Mitsui Fine Chemicals, Inc.

### Examples 5 to 8, Comparative Examples 2 to 4

Each component of the type and blending amount listed in Table 3 was inserted into a Henschel mixer and mixed, after which the mixture was inserted into a twin-screw kneader heated to 110° C., and the mixture was heated and kneaded until becoming uniform. The heated and kneaded product was inserted into a cold roll, extended into a sheet shape, and then pulverized, whereby a composite was produced.

### [Measurement Evaluation of Composite]

A molded body having a thickness of 0.5 mm or 1.0 mm was compression molded (temperature; 175° C., pressure; 10 MPa) from the obtained composite. The complex dielectric constant, and the electromagnetic wave absorption performance were measured by the following methods. The evaluation results are shown in Table 3.

### <Complex Dielectric Constant (Real Part: ε′, Imaginary Part: ε″)>

The dielectric characteristics were measured within a frequency range of from 8.20 GHz to 12.40 GHz at a temperature of 25° C. using a molded body having a thickness of 1.0 mm, a network analyzer (Agilent PNA E8363B), and a rectangular waveguide (WRJ-10), and each value at 10 GHz was determined.

### <Electromagnetic Wave Absorption Performance (Frequency: 10 GHz)>

A molded body molded to have a thickness of 0.5 mm was installed between a high-frequency oscillating device and a reception antenna. The electromagnetic wave intensity when electromagnetic waves having a frequency of 10 GHz were generated was measured for both a case in which the molded body was present and a case in which the molded body was not present. The ratio of the electromagnetic wave intensities of both cases ((electromagnetic wave intensity when electromagnetic waves were absorbed by the molded body)/(electromagnetic wave intensity when the molded body was not present)) was then expressed in units of dB and used as electromagnetic wave absorption performance.

The electromagnetic wave intensity was measured in accordance with the “IEICE Transactions on Fundamentals of Electronics, Communications, and Computer Sciences B, Vol. J97-B, No. 3, pp. 279-285”

### <Volume Resistivity>

The volume resistivity at 150° C. was measured in accordance with JIS K-6911:2006 using a molded body molded to have a thickness of 1.0 mm.

TABLE 3

| | Composite [mass %] | | | | | | | |
|---|---|---|---|---|---|---|---|---|
| | Organic | | Curing | | | | | |
| | substance | Inorganic | agent | Curing | Flame | Carbon material | | |
| | Epoxy | substance | Phenolic | accelerator | retardant | Composite | Composite | Composite |
| | resin | Silica | resin | Imidazole | Phosphazene | material 1 | material 2 | material 3 |
| Example 5 | 13.3 | 70 | 6.2 | 0.4 | 10 | 1 | — | — |
| Example 6 | 13.3 | 70 | 6.2 | 0.4 | 10 | — | 1 | — |
| Example 7 | 13.3 | 70 | 6.2 | 0.4 | 10 | — | — | 10 |
| Example 8 | 13.3 | 70 | 6.2 | 0.4 | 10 | — | — | — |
| Comparative | 13.3 | 70 | 6.2 | 0.4 | 10 | — | — | — |
| Example 2 | | | | | | | | |
| Comparative | 13.3 | 70 | 6.2 | 0.4 | 10 | — | — | — |
| Example 3 | | | | | | | | |
| Comparative | 13.3 | 70 | 6.2 | 0.4 | 10 | — | — | — |
| Example 4 | | | | | | | | |

| | | | | Evaluation | | | |
|---|---|---|---|---|---|---|---|
| | | | | | Imaginary | Electro- | |
| | | | | Real part (ε′) | part of | magnetic | |
| | | | | of complex | complex | wave | |
| | Composite [mass %] | | | dielectric | dielectric | absorption | |
| | Carbon material | | | constant | constant (ε″) | performance | Volume |
| | Composite | | | 10 GHz | 10 GHz | 10 GHz | resistivity |
| | material 4 | CNF | CNT | [—] | [—] | [dB] | Ω · cm |
| Example 5 | — | — | — | 5.0 | 1.2 | −8 | 1.0 × 10⁸ |
| Example 6 | — | — | — | 5.0 | 1.5 | −10 | 1.0 × 10⁸ |
| Example 7 | — | — | — | 20.0 | 1.4 | −9 | 1.0 × 10⁹ |
| Example 8 | 10 | — | — | 21.0 | 1.5 | −10 | 1.0 × 10⁹ |
| Comparative | — | 0.5 | — | 4.0 | 0.3 | 0 | 1.0 × 10⁹ |
| Example 2 | | | | | | | |
| Comparative | — | — | 0.3 | 7.0 | 2.0 | −8 | 1.0 × 10⁵ |
| Example 3 | | | | | | | |
| Comparative | — | — | — | 3.0 | 0.1 | 0 | 1.0 × 10¹⁰ |
| Example 4 | | | | | | | |

As shown in Table 3, the composites of Examples 5 to 8 containing the composite material having the honeycomb structure containing a cellulose nanofiber and a carbon material having a specific structure had good electromagnetic wave absorption performance, high volume resistivity, and good insulation properties.

1. A composite material comprising a honeycomb structure comprising:
a cellulose nanofiber; and
a carbon material,
the carbon material comprising at least one selected from a carbon material (a) and a carbon material (b), the carbon material (a) comprising at least one selected from a first shell-shaped body and a second shell-shaped body, the first shell-shaped body comprising a hollow particle having one pore, and the second shell-shaped body having a shape in which hollow particles are connected and having a plurality of pores, and the carbon material (b) comprising at least one selected from a core-shell particle in which a surface of an inorganic particle is coated with a carbon layer and a core-shell connected body in which a surface of a connected body of inorganic particles is coated with a carbon layer.

2. The composite material according to claim 1, wherein in the carbon material (a), shell portions of the first shell-shaped body and the second shell-shaped body are made of graphene having an average number of layers of 4 or less, and in the carbon material (b), the carbon layer is made of graphene having an average number of layers of 4 or less.

3. The composite material according to claim 1, wherein the carbon material (a) has a specific surface area of 657 m²/g or more.

4. The composite material according to any one of claim 1, wherein in the carbon material (a), volumes of the pore of the first shell-shaped body and the pores of the second shell-shaped body are 1.0 cc/g or more.

5. The composite material according to any one of claim 1, wherein a honeycomb opening diameter of the honeycomb structure is not less than 0.2 μm and not more than 200 μm.

6. The composite material according to any one of claim 1, wherein a content of the carbon material contained in the composite material is not less than 5 mass % and not more than 95 mass %.

7. The composite material according to any of claim 1, wherein the honeycomb structure is made of the cellulose nanofiber and the carbon material.

8. The composite material according to any one of claim 1, wherein the honeycomb structure is made of the cellulose nanofiber, and the carbon material is attached to a surface of the honeycomb structure.

9. A method for producing the composite material according to claim 7, the method comprising mixing a carbon material and an aqueous dispersion containing a cellulose nanofiber and freezing, the carbon material comprising at least one selected from a carbon material (a) and a carbon material (b), the carbon material (a) comprising at least one selected from a first shell-shaped body and a second shell-shaped body, the first shell-shaped body comprising a hollow particle having one pore, and the second shell-shaped body having a shape in which hollow particles are connected and having a plurality of pores, and the carbon material (b) comprising at least one selected from a core-shell particle in which a surface of an inorganic particle is coated with a carbon layer and a core-shell connected body in which a surface of a connected body of inorganic particles is coated with a carbon layer.

10. The method for producing the composite material according to claim 8, the method comprising impregnating a honeycomb structure comprising a cellulose nanofiber with a dispersion containing a carbon material comprising at least one selected from a carbon material (a) and a carbon material (b), the carbon material (a) comprising at least one selected from a first shell-shaped body and a second shell-shaped body, the first shell-shaped body comprising a hollow particle having one pore, and the second shell-shaped body having a shape in which hollow particles are connected and having a plurality of pores, and the carbon material (b) comprising at least one selected from a core-shell particle in which a surface of an inorganic particle is coated with a carbon layer and a core-shell connected body in which a surface of a connected body of inorganic particles is coated with a carbon layer.

11. The method for producing the composite material according to claim 9, wherein in the carbon material (a), shell portions of the first shell-shaped body and the second shell-shaped body are made of graphene having an average number of layers of 4 or less, and in the carbon material (b), the carbon layers are made of graphene having an average number of layers of 4 or less.

12. The composite material according to claim 1, which is an electromagnetic interference suppression material.

13. A composite comprising:
the composite material according to claim 1; and
at least one selected from an organic substance and an inorganic substance.

14. The composite according to claim 13, wherein the organic substance is a thermosetting resin.

15. The composite according to claim 13, which is an electromagnetic interference suppression material.

16. The method for producing the composite material according to claim 10, wherein in the carbon material (a), shell portions of the first shell-shaped body and the second shell-shaped body are made of graphene having an average number of layers of 4 or less, and in the carbon material (b), the carbon layers are made of graphene having an average number of layers of 4 or less.
